(19) United States
(12) Patent Application Publication
(10) Pub. No.: US 2026/0288693 A1
(43) Pub. Date: Sep. 24, 2026

(54) DATA LOADING ENGINE FOR COMPLEX DATA LOADING

(71) Applicant: PAYPAL, INC,, San Jose, CA (US)

(72) Inventors: Prabin Patodia, Kolkata (IN); Rajendra Bhat, Bangalore Urban (IN)

(21) Appl. No.: 19/085,170

(22) Filed: Mar. 20, 2025

(51) Int. Cl. G06F 16/22

(52) U.S. Cl. CPC G06F 16/2264

(57) ABSTRACT

The disclosed computer-implemented method may relate to a data loading process that involves retrieving data objects and using data producers and data consumers. The method may include determining a dependency hierarchy for the data objects, the data producers, and the data consumers and generating a graph based on the dependency hierarchy. The graph may include various levels, each having nodes representing the data objects, data producers, and/or data consumers, and links between nodes of different levels may represent data routes. The method may further include executing the data loading process using the data routes from the graph to produce a final set of data objects. Various other methods, systems, and computer-readable media are also disclosed.

### TECHNICAL FIELD

This application relates to data retrieval. More specifically, this application relates to complex data loading involving retrieval/reformatting data as inputs into a system.

### BACKGROUND

This application is directed to a data loading engine for complex data loading processes. With the growth of data, computing systems and networks for managing and processing data have become increasingly complex. Various data processing systems rely on data inputs that must first be retrieved. Decision engines such as artificial intelligence (AI), statistical analytics, and other predictive analytics rely on specific data inputs to produce desired outputs. The data inputs are often retrieved or loaded from various sources, and often require reformatting or transformation to be used as inputs.

These decision engines may improve performance, such as through updated methodologies, higher performing processors/memory, etc. However, the data loading process itself may present a bottleneck to overall performance. Often, a decision engine may wait idly until a full input data set is available. The data loading process, particularly for complex data (e.g., having numerous variables/parameters to be loaded and requiring transformations or reformatting of certain data), is often loaded step-by-step or otherwise may be an inefficient process.

As referred to herein artificial intelligence (AI) generally refer to machines (e.g., software and/or hardware) developed to think and/or act like humans. Further, although the examples herein relate to AI and/or machine learning (ML) models (e.g., programs and/or systems trained from input data to output predictions or decisions, including unsupervised, supervised, and/or reinforcement learning models), the AI/ML models referred to herein may correspond to any type of AI technology, including various types of machine learning, neural network (NN) (e.g., having a structure of input layers, one or more hidden layers, and an output layer, each layer performing calculations with input from a previous layer using trained/learned weights), deep learning (DL) (e.g., NN with more than three hidden layers), generative AI (GenAI) (e.g., AI trained to generate content such as text, images, video, audio, etc. as learned from existing content), large language model (LLM) (a GenAI for natural language processing to generate human-like text), etc. (e.g., any other AI model).

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for a data loading engine for complex data loading.

FIG. 2 is a block diagram of an example network for a data loading engine for complex data loading.

FIG. 3 is a block diagram of an example architecture of a data loading engine for complex data loading.

FIG. 4 is an example graph representing a complex data loading process.

FIGS. 5A-B are example graphs representing the complex data loading process illustrated in FIG. 4.

FIG. 6 is a flow diagram of an example method for complex data loading using a data loading engine.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to a data loading engine for complex data loading. As will be explained in greater detail below, embodiments of the present disclosure may determine a dependency hierarchy for a data loading processing that includes retrieving data objects with data producers and/or data consumers, generating a graph having nodes organized into levels and edges as data routes based on the dependency hierarchy, and executing the data loading process based on the data routes to produce a final set of data objects. The systems and methods described herein may advantageously allow a more efficient and flexible data loading process by creating a graph that may account for utilization of processor resources, consolidate sources, as well as identify dynamic changes in response to failures. The systems and methods provided herein may advantageously improve the functioning of a computer system by more efficiently routing data, reducing network communications, and by efficiently scheduling processing tasks. The systems and methods provided herein may also improve the fields of data loading, data processing, data management, and artificial intelligence by providing scalable solutions for complex data input management.

Features from any of the embodiments described herein may be used in combination with one another in accordance with the general principles described herein. These and other embodiments, features, and advantages will be more fully understood upon reading the following detailed description in conjunction with the accompanying drawings and claims.

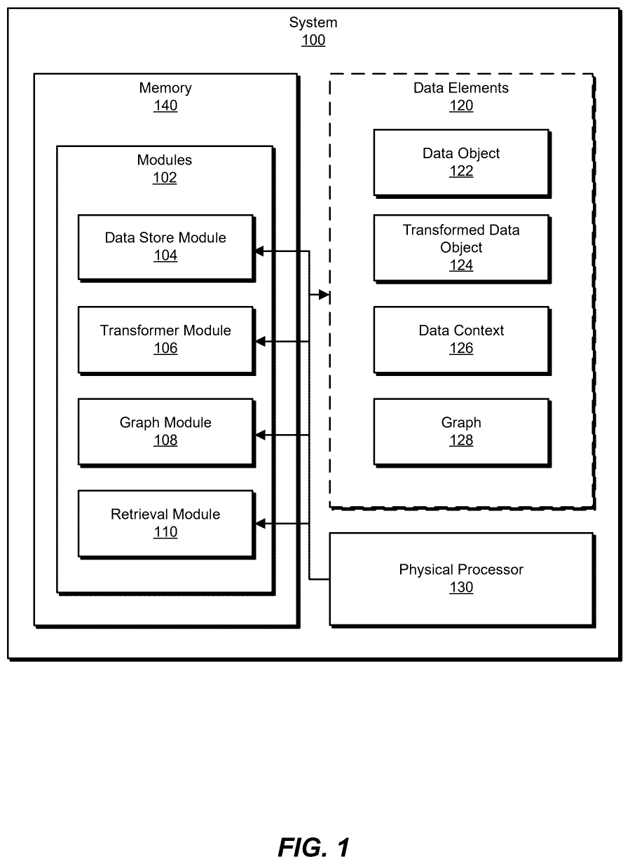

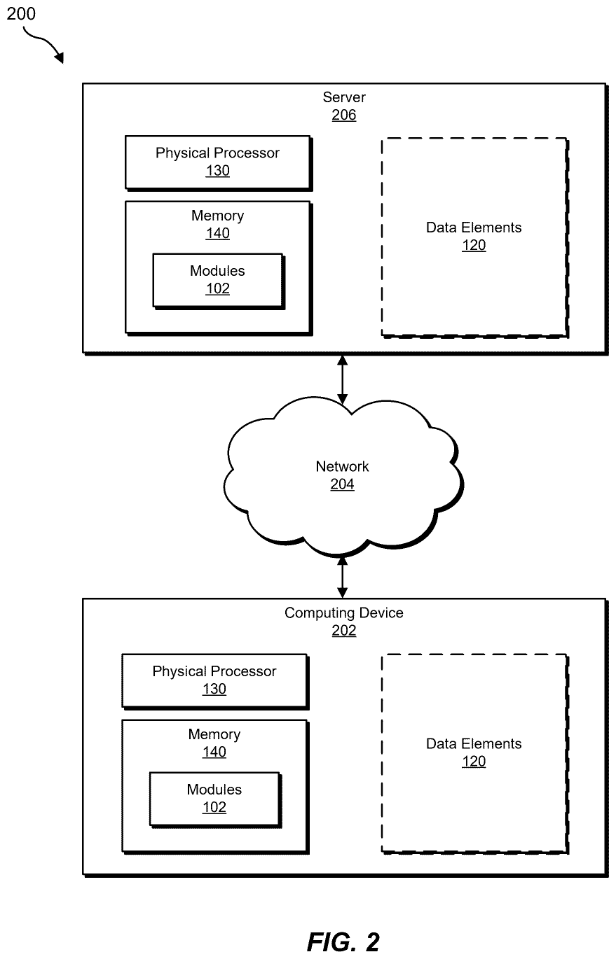

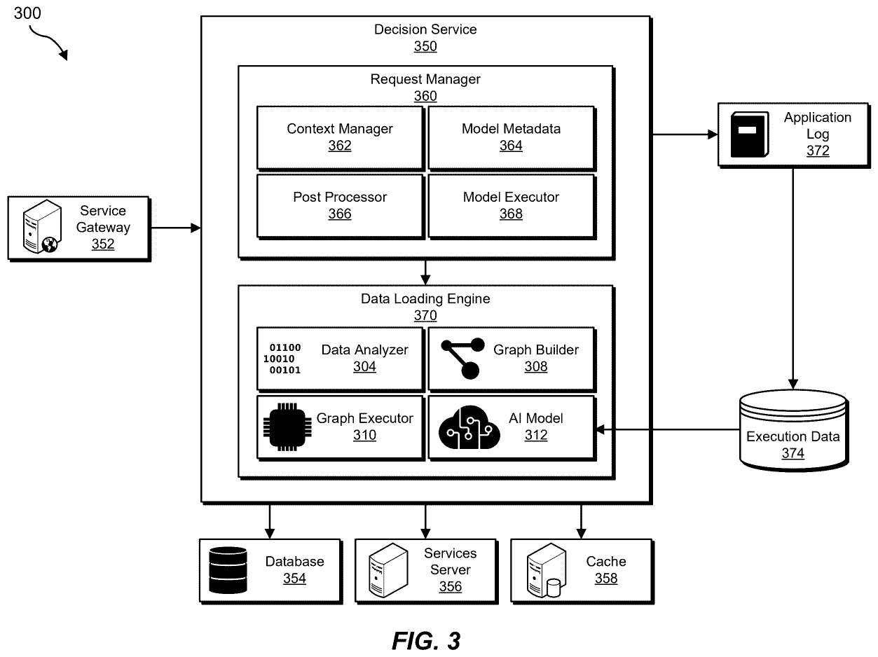

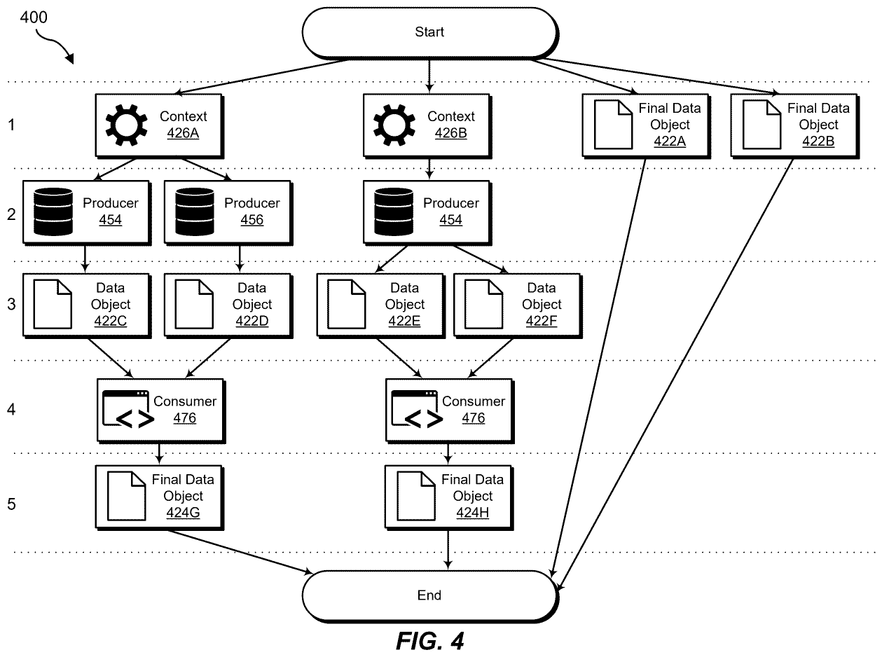

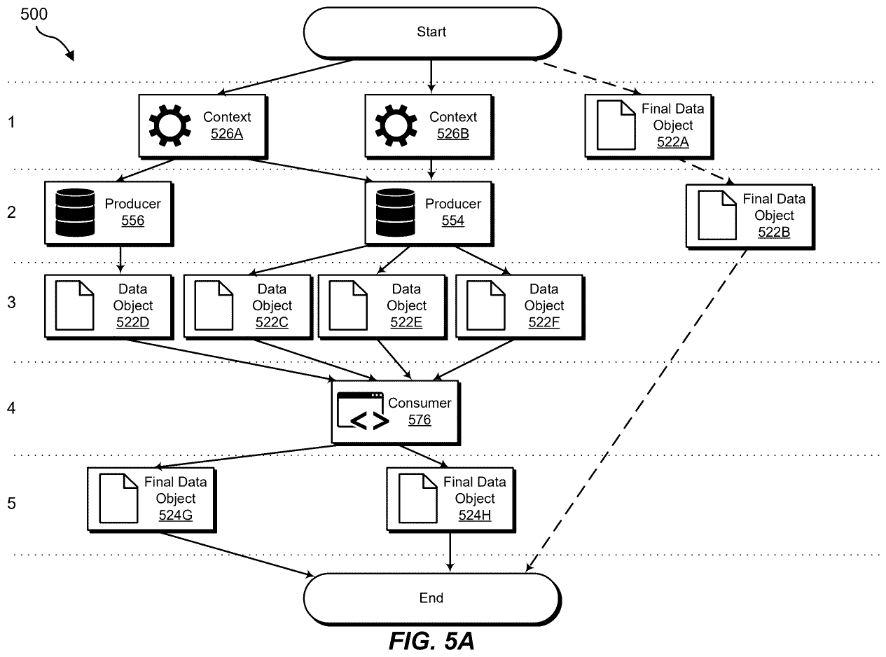

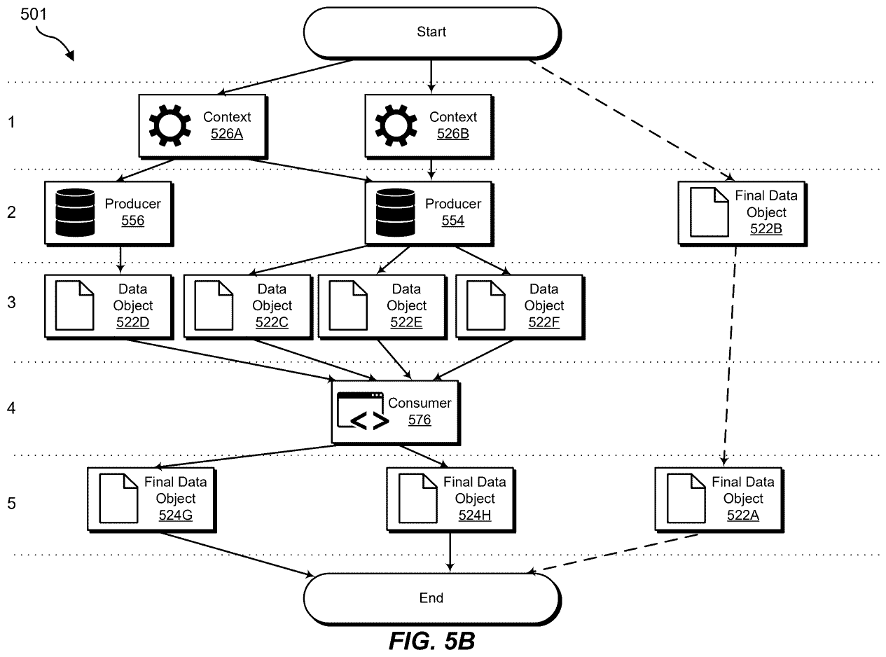

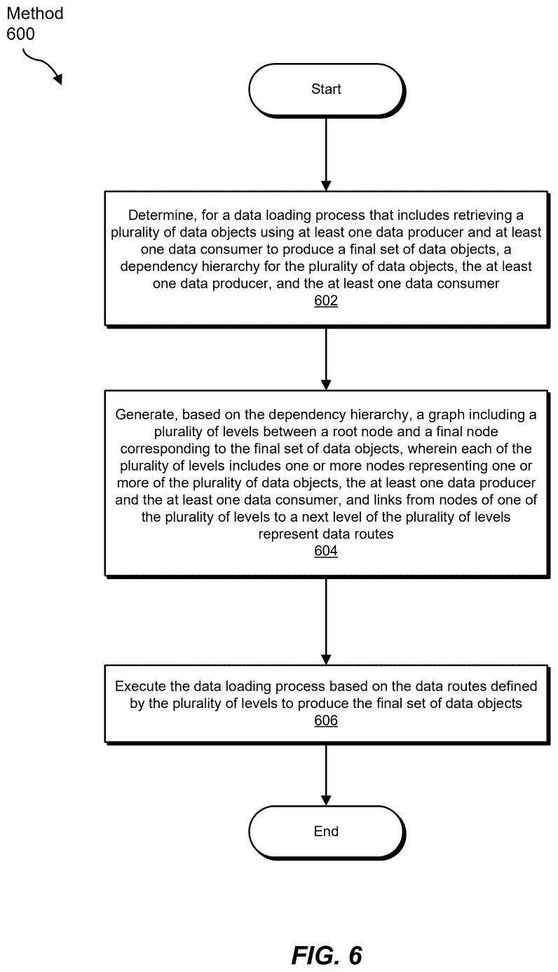

The following will provide, with reference to FIGS. 1-6, detailed descriptions of a data loading engine for complex data loading. Detailed descriptions of example computing systems for a data loading engine will be provided in connection with FIGS. 1 and 2. Detailed descriptions of an example architecture for a data loading engine will be provided in connection with FIG. 3. Detailed descriptions of example graphs for a data loading engine will be provided in connection with FIGS. 4 and 5A-5B. In addition, detailed descriptions of an example method for complex data loading with a data loading engine will be provided in connection with FIG. 6.

Various systems described herein may perform the processes described herein. FIG. 1 is a block diagram of an example system 100 for a data loading engine for complex data loading. As illustrated in this figure, example system 100 may include one or more modules 102 for performing one or more tasks. As will be explained in greater detail herein, modules 102 may include a data store module 104, a transformer module 106, a graph module 108, and a retrieval module 110. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate complex data loading. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), graphics processing units (GPUs), hardware accelerators, co-processors, portions of one or more of the same, variations or combinations of one or more of the same, and/or any other suitable physical processor.

As illustrated in FIG. 1, example system 100 may also include one or more data elements 120, such as a data object 122, a transformed data object 124, a data context 126, and a graph 128. In some implementations, data object 122, transformed data object 124, data context 126, and/or graph 128 may be stored on a local storage device, such as memory 140, or may be accessed remotely. Data object 122 may represent any data (also referred to herein as a data item) to be extracted or otherwise retrieved, in either a raw, aggregated, and/or processed form, one or more discrete units of data (e.g., variables, parameters, attributes, etc.), and/or metadata (e.g., context describing what type/kinds of data and/or relationships thereof, instructions/filters for processing data, etc.), as will be explained further below. Transformed data object 124 may represent data that has been processed (e.g., extracted from a larger data object, changed in format, applied calculations, etc.), such as a processed form of an instance of data object 122, as will be explained further below. Data context 126 may represent contextual indications for data objects, such as signals for what types of data to be used/retrieved/processed, sources of data, relationships between data objects, etc., as will be explained further below. Graph 128 may represent one or more graphs, such as a directed acyclic graph (DAG) that organizes a complex data loading process into levels or stages, nodes for each level/stage representing a processing operation (e.g., loading a data object, transforming a data object, etc.) and edges/connections between nodes representing data routes for processing in sequence, as will be explained further below.

Example system 100 in FIG. 1 may be implemented in a variety of ways. For example, all or a portion of example system 100 may represent portions of example network environment 200 in FIG. 2.

FIG. 2 illustrates an example network environment 200 implementing aspects of the present disclosure. The network environment 200 includes computing device 202, a network 204, and server 206. Computing device 202 may be a client device or user device, such as a desktop computer, laptop computer, tablet device, smartphone, or other computing device. Computing device 202 may include a physical processor 130, which may be one or more processors, and memory 140, which may store, modify, and/or access data such as one or more of data elements 120. In addition, although not illustrated, the computing devices described herein, including computing device 202, may also include or otherwise be communicatively coupled to one or more input/output devices (e.g., a display, a speaker, a user input device, etc.).

Server 206 may represent or include one or more servers capable of hosting and/or processing data. Server 206 may facilitate complex data loading processes in conjunction with computing device 202. Server 206 may include a physical processor 130, which may include one or more processors, memory 140, which may store modules 102, and store, modify, and/or access one or more of data elements 120.

Computing device 202 may be communicatively coupled to server 206 through network 204. Network 204 may represent any type or form of communication network, such as the Internet, and may comprise one or more physical connections, such as LAN, and/or wireless connections, such as WAN, Wi-Fi, cellular, and/or short-range wireless connections.

FIG. 3 illustrates a system 300 for a decision service using a data loading engine, portions of which may correspond to one or more of system 100, computing device 202, server 206, and/or portions thereof. FIG. 3 includes a decision service 350 which may represent any decision engine as described herein (e.g., computer software and/or hardware that may analyze inputs to produce an output, such as a decision on whether to allow or deny a transaction, a classification of data, a prediction of a result, a statistical analysis, etc.). A service gateway 352 representing a server (corresponding to an instance of server 206), may allow users and/or another computing device (e.g., an instance of computing device 202) to access (e.g., provide requests and receive results) decision service 350. Decision service 350 may be hosted on service gateway 352 or any other server.

Decision service 350 may be communicatively coupled to various sources of data, represented in FIG. 3 with a database 354, a services server 356, and a cache 358, although in other examples, there may be additional or fewer data sources. Database 354 may correspond to a database (e.g., an instance of server 206) or other data store for maintaining data. Services server 356 may represent a computing device (e.g., an instance of server 206) that may process data and further provide data (e.g., as part of another data processing service). Cache 358 may represent another data store (e.g., an instance of server 206). Decision service 350 may also be communicatively coupled to an application log 372 representing a log of applications (e.g., logs relating to executing applications or other programs such as requesting and/or transforming data) that may be stored on a computing device (e.g., an instance of server 206). Decision service 350 may further be communicatively coupled to an execution data 374 representing a database (e.g., an instance of server 206) having historic aggregated execution statistics about data.

Decision service 350 also includes a request manager 360 for managing/processing incoming requests, and a data loading engine 370 for efficient execution of complex data loading processes for the incoming requests. Request manager 360 may include a context manager 362 for receiving incoming requests and contextual data related to the requests, a model metadata 364 for maintaining metadata of the models available for execution as well as additional data required for each model, a post processor 366 for executing post processing related tasks once decision service 350 completes all request processing related tasks (e.g., after taking a decision, logging the decision, forwarding the event for further processing, etc.). Data loading engine 370 (which may correspond to one or more of modules 102) may include a data analyzer 304 (e.g., corresponding to data store module 104 and/or transformer module 106) that may analyze each data object (e.g., data object 122) and its related metadata (e.g., data context 126) and provide such details to a graph builder 308, graph builder 308 (e.g., corresponding to graph module 108) that may build data graphs (e.g., graph 128) as will be described further below, an AI model 312 (e.g., corresponding to graph module 108) representing an AI or ML model used to build graphs, and a graph executor 310 (e.g., corresponding to retrieval module 110) that may execute the graphs. Example graphs are illustrated in FIGS. 4 and 5A-5B.

FIG. 4 illustrates a graph 400 of a data loading process, for example as performed by a decision service such as decision service 350 (e.g., data loading engine 370 and in some examples by graph executor 310). Graph 400 may represent a graph that may be built (e.g., by data loading engine 370 and in some examples by graph builder 308) in response to a request (e.g., from service gateway 352) that may require loading data. The request may correspond to a request for a prediction or other decision by the decision service, which may require loading data to make the prediction/decision and respond to the request. For example, the decision service may require specific inputs, such as data objects as represented in FIG. 4 by a final data object 422A, a final data object 422B, a final data object 424G, and a final data object 424H (each representing separate instances of data object 122). The nodes may represent data objects, producers, consumers, etc. A producer, as referred to herein, may in some examples represent a datastore, data source, and/or process/service (e.g., computing device and/or software) that may produce an output data object that may be based on input parameters. A consumer, as referred to herein, may in some examples represent a datastore, data source, and/or process/service (e.g., computing device and/or software) that may produce an output (e.g., an output data object) based on processing input data object(s). The links between nodes may represent data routes (e.g., paths for sending data from one node to another).

The decision service (e.g., request manager 360) may determine the final data objects required, based on the request. The data loading process may reflect a loading sequence for each of the final data objects. For example, loading final data object 424G may require retrieving and transforming data. A context manager (e.g., context manager 362) and/or a model metadata (e.g., model metadata 364) may determine what data to retrieve, which sources are available to retrieve data, what parameters and/or metadata for retrieving data, what transformations are needed, etc. for producing the final data objects.

With respect to final data object 424G, the context manager may determine a context 426A (corresponding to an instance of data context 126) for retrieving data, such as parameters relating to data as well as particular sources. Context 426A may indicate retrieving particular data objects from a producer 454 and a producer 456 (e.g., corresponding to one or more of database 354, services server 356, and/or cache 358). Context 426A may include parameters for requesting a data object 422C (e.g., an instance of data object 122) from producer 454, and a data object 422D (e.g., another instance of data object 122) from producer 456. For example, context 426A may include parameters for identifying particular data as well as parameters for types of data.

Data object 422C and data object 422D may further represent intermediate data objects in that further transformation may be needed. A consumer 476 (e.g., corresponding to one or more of database 354, services server 356, cache 358 and/or decision service 350) may represent a process for transforming data (e.g., a transformer for processing data objects from one form/format to another form/format, including reformatting data, adding/removing data/metadata, combining data, etc.) as determined by the request manager. As illustrated in FIG. 4, data object 422C and data object 422D may be processed by a consumer 476 (e.g., a transformer). Consumer 476 may accordingly produce final data object 424G, which may be a combination and reformatting of data object 422C and data object 422D based on parameters/metadata determined by the request manager.

With respect to final data object 424H, the context manager may determine a context 426B (corresponding to another instance of data context 126) for retrieving data, such as parameters relating to particular data from a particular source. Context 426B may indicate retrieving a data object from producer 454. Context 426B may include parameters for requesting a data object 422E (e.g., an instance of data object 122) and a data object 422F (e.g., an instance of data object 122) from producer 454. For example, context 426B may include parameters for identifying particular data as well as parameters for types of data.

Data object 422E and data object 422F may further represent intermediate data objects in that further transformation may be needed by consumer 476 as determined by the request manager. As illustrated in FIG. 4, data object 422E and data object 422E may be processed by consumer 476 to accordingly produce final data object 424H, which may be a combination and reformatting of data object 422E and data object 422F based on parameters/metadata determined by the request manager.

The final data objects (e.g., final data object 422A, final data object 422B, final data object 424G, and final data object 424H) may then be used by the decision service for a prediction/decision. FIG. 4 illustrates graph 400 of a complex data loading process for loading the final data objects (e.g., requiring multiple contexts, sources, transformations, etc.) following a straightforward pattern (e.g., generally linear data routes for loading each data object). However, FIG. 4 illustrates certain potential inefficiencies.

FIG. 4 illustrates levels to graph 400 (e.g., 1-5) representing stages of the data loading process to be completed before proceeding to a next stage. In some examples, these levels/stages may also represent processing resources, namely processing cycles of the computing devices (e.g., system 100, computing device 202, server 206, decision service 350, database 354, services server 356, cache 358, etc.). Each level may require a certain number of processor cycles (e.g., for processing data, waiting for data to be retrieved/returned, I/O calls, etc.), using up available processor cycles at each level. In some scenarios, the required cycles for a level may exceed available cycles for the level (e.g., requiring another level's worth of cycles to complete), and in other scenarios (including when another level's worth of cycles is needed), the total available cycles may exceed what is required, leaving unutilized cycles. In other words, the utilization of cycles may be inefficient. For instance, FIG. 4 illustrates certain levels (e.g., 1 and 3) being more loaded than other levels.

In addition, graph 400 may not account for I/O calls having common sources/destinations (e.g., common producer and/or consumer nodes). For example, level 2 includes two different calls to producer 454, and level 4 includes two different calls to consumer 476. In other words, certain data routes may be grouped into batches.

FIG. 5A illustrates a graph 500 and FIG. 5B illustrates a graph 501, which may both correspond to the data loading process of FIG. 4, for example a similar request which may be processed by a decision service (e.g., decision service 350) and in some examples by a request manager (e.g., request manager 360) and a data loading engine (e.g., data loading engine 370). Graph 500 and graph 501 may mitigate some of the potential inefficiencies of graph 400 or otherwise provide some optimization of graph 400.

FIGS. 5A-5B includes similar elements as FIG. 4, including a context 526A (corresponding to context 426A), a context 526B (corresponding to context 426B), a final data object 522A (corresponding to final data object 422A), a final data object 522B (corresponding to final data object 422B), a producer 554 (corresponding to producer 454), a producer 556 (corresponding to producer 456), a data object 522C (corresponding to data object 422C), a data object 522D (corresponding to data object 422D), a data object 522E (corresponding to data object 422E), a data object 522F (corresponding to data object 422F), a consumer 576 (corresponding to consumer 476), a final data object 524G (corresponding to final data object 424G), and a final data object 524H (corresponding to final data object 424H).

Similar to FIG. 4, in FIGS. 5A-5B a decision service (e.g., decision service 350), may receive a request (e.g., from service gateway 352) for a prediction or other decision, which may require loading data as inputs. A request manager (e.g., request manager 360) of the decision service may process the request for a data loading engine (e.g., data loading engine 370) to determine a data loading process by building a graph (e.g., by graph builder 308 in conjunction with data analyzer 304 and AI model 312) and executing the graph (e.g., by graph executor 310) to load the final data objects (e.g., final data object 522A, final data object 522B, final data object 524G, final data object 524H) as inputs for the decision process.

In some examples, the request received by the decision service may identify the inputs (e.g., the final data objects) and related parameters. In other examples, the request manager (e.g., context manager 362, model metadata 364, post processor 366, and/or model executor 368) may identify parameters relevant for completing the request, such as a type of request (e.g., type of decision/prediction), input data needed for the request (e.g., based on the type of request), parameters relating to the input data (e.g., sources of data, contexts and/or metadata for extracting specific data from the sources, transformations needed, etc.), etc., and forward these parameters to the data loading engine.

The data loading engine may build a graph (e.g., a Directed Acyclic Graph (DAG) or other appropriate graph structure) to represent a data loading process for complex data loading. Based on the desired final data objects for the request, the data loading engine (e.g., data analyzer 304) may determine data dependencies for the final data objects. The data routes for certain final data objects (e.g., final data object 524G and final data object 524H) may require data dependencies (e.g., requirements for loading/transforming by nodes such as producer 556, producer 554, and/or consumer 576, requirements on other data objects, and/or otherwise indicating intermediate processes/data objects such as data object 522C, data object 522D, data object 522E, and data object 522F before producing the final data object) which may further be batched based on common nodes. In addition, certain other final data objects (e.g., final data object 522A and final data object 522B) may not have data dependencies (e.g., having no prerequisites such as loading from a particular node and having no postrequisites such as transformation by a particular node, no dependencies on other data objects, and/or otherwise indicating no requirements for intermediate processes/data objects before producing the final data object) such that the data routes may represent independent nodes. In some implementations, the data loading engine may establish or otherwise store the data dependencies as metadata, context data, etc. Further, in some examples, the data loading engine may identify each final data object's dependencies, and compare/combine the dependencies, although in other examples, the data loading engine may analyze dependencies in other ways (e.g., identifying common nodes first, building an initial graph as in FIG. 4 and performing graph analysis, etc.).

For data objects having dependencies, the data loading engine may identify common data store or sources (e.g., database 354, services server 356, and/or cache 358) from the data dependencies to group or otherwise batch data retrievals together for common data sources. For example, in FIG. 5, the data loading engine may batch data retrievals for context 526A and context 526B into a single (albeit potentially larger) data retrieval for producer 554 (at level 2), as compared to FIG. 4 in which producer 454 has two retrievals (for context 426A and separately for context 426B at level 2). The batched data retrieval may further include the appropriate contexts (e.g., context 526A and context 526B) as well as other relevant parameters for outputting the desired data objects (e.g., data object 522C, data object 522E, and data object 522F), which in some implementations may maintain the same intermediate/final data objects as without the batching (e.g., as in FIG. 4).

Similarly, the data loading engine may identify common data transformers from the data dependencies to group or batch together transformation requests for common data transformers. For example in FIG. 5, the data loading engine may batch together transformations for data object 522D, data object 522C, data object 522E, and data object 522F into a single (albeit potentially larger) data transformation for consumer 576 (at level 4), as compared to FIG. 4 in which consumer 476 has two data transformations (one for data object 422C and data object 422D, and a separate one for data object 422E and data object 422F at level 4). The batched data transformation may further include the appropriate data objects (e.g., data object 522D, data object 522C, data object 522E, and data object 522F) as well as other relevant parameters for outputting the desired data objects (e.g., final data object 524G, and final data object 524H), which in some implementations may maintain the same intermediate/final data objects as without the batching (e.g., as in FIG. 4).

The data loading engine (e.g., graph builder 308) may then build a graph (e.g., graph 128) based on the grouped/batched data retrievals and grouped/batched data transformations (e.g., as in graph 500 in FIG. 5A and graph 501 in FIG. 5B). For example, FIG. 5A illustrates data routes organized based on the grouped data retrievals (e.g., at levels 1-3) and the grouped data transformations (e.g., at levels 3-5) based on the data dependencies. In some implementations, the data loading engine may build an initial graph (e.g., resembling graph 400) and modify the initial graph, and in other implementations, the data loading engine may build a graph reflecting the batching, and further modify as needed.

As stated above, certain data objects may be independent (e.g., final data object 522A and final data object 522B), represented as independent nodes in FIGS. 5A-5B, such that placement of the independent nodes within the levels of graph 500 and/or graph 501 may not be restricted by data dependencies. In FIG. 4, the independent data objects (e.g., final data object 422A and final data object 422B) may be arbitrarily placed in the first level. However, in some examples, such placement may lead to inefficiencies. For instance, although FIG. 4 illustrates only two independent data objects, other examples may include numerous other independent data objects such that level 1 may be top loaded with all the independent data objects. In other words, FIG. 4 may not take advantage of parallel processing opportunities with the independent data objects. In contrast, FIGS. 5A-5B illustrate a staggered loading of the independent data objects. In other words, identifying the independent data objects affords flexibility in when to load the independent data objects (e.g., represented by flexible placement in levels). In FIG. 5A, final data object 522A may be loaded in level 1 (and in level 5 in FIG. 5B as will be explained further below), and final data object 522B may be loaded in level 2 (and also in level 2 in FIG. 5B). In addition, as the data routes for the independent data objects may not reflect true data routes (e.g., final data object 522A and final data object 522B are not dependent on each other), the connecting edges are illustrated as dashed lines in FIGS. 5A-5B.

In some implementations, the data loading engine may further leverage the flexible placement of independent nodes in the graph for improved efficiency. As stated above, each level of the graph may represent computing resources, which may be represented, approximated, or otherwise correspond to performance metrics such as number of cycles, time to execute, etc. To determine potential computing resource requirements for each level, the data loading engine may analyze historical data for similar data loading processes and/or sub-processes (e.g., data retrievals, data transformations, etc.).

The decision service may record, in an application log (e.g., application log 372), data reflecting performance and/or computing resource requirements. For example, the application log may include historical data logging various when an application ran, when it ended, which computing devices were accessed, inputs and outputs, etc. In some implementation, the application log may be analyzed to derive execution data (e.g., execution data 374), which may include identifiers for processes (IO or data retrievals, transformations, etc.), sources (e.g., producers), transformers (e.g., consumers), etc. along with related performance metrics (e.g., time to execute and/or start/end timestamps, number of cycles used, etc.). The performance metrics may be direct (e.g., number of cycles, what processors were used) or indirect (e.g., an execution time as a proxy or otherwise represent computing resources needed).

The data loading engine may analyze the execution data, for example using an AI model (e.g., AI model 312) trained (e.g., using execution data 374) to predict computing resources needed for various processing tasks. For example, the data loading engine may predict (e.g., using AI model 312) an expected execution time (e.g., a total time needed to perform the task such as loading, retrieving, transforming, etc., as a proxy for computing cycles needed) for each process (e.g., data retrievals, data transformations, etc.) to determine a total expected execution time for each level of the graph, which in some implementations may not include any processing for independent nodes. The data loading engine (e.g., graph builder 308) may compare, for each level, the total expected execution time with a threshold execution time. The threshold execution time (which may be determined by the AI model) may represent a computing resource budget for a given level (e.g., a number of processor cycles available before requiring another level's worth of processor cycles, a processor capacity, etc.). For a given level, the total expected execution time not exceeding the threshold execution time may indicate that the level is not overburdened (e.g., has not exceeded the processor capacity), and a difference between the threshold execution time and the total expected execution time (e.g., subtracting the total expected execution time from the threshold execution time) may indicate available computing resources (e.g., having available processor capacity). Thus, increasing the total expected execution time without exceeding the threshold execution time may indicate increased efficiency for the level (e.g., maximizing or otherwise improving utilization of available computing resources). Accordingly, the data loading engine may organize the various data routes so as to avoid exceeding the threshold execution time for each level of the graph.

The data loading engine may further allocate independent nodes in levels of the graph so as to avoid exceeding the threshold execution time for each level of the graph, for example by determining the expected execution time for the independent data objects, and placing the independent data objects into levels having available processor capacity for the independent data object (e.g., such that the total expected execution time for the level including the execution time for the independent data object does not exceed the threshold execution time). In some examples, exceeding the threshold may be unavoidable such that the placement may be based on minimizing an amount of exceeding the threshold. Accordingly, the independent data objects may be loaded in any order and any level as determined by the data loading engine.

After building the graph (e.g., graph 500), the data loading engine (e.g., graph executor 310) may perform the data loading process for the final data objects by executing the graph. The data loading engine may execute the graph by executing successive stages (represented by the levels) of the various data routes as established in the graph. For example, following graph 500, the data loading engine may perform the first stage (e.g., level 1) by sending context 526A to producer 556 and producer 554, sending context 526B to producer 554, and loading final data object 522A. For level 2, producer 556 may process context 526A (for producing data object 522D), producer 554 may process context 526A and context 526B (for producing data object 522C, data object 522E, and data object 522F), and the data loading engine may load final data object 522B. For level 3, the data loading engine may retrieve/send data object 522D, data object 522C, data object 522E, and data object 522F to consumer 576 for processing (e.g., transforming) at level 4. At level 5, the data loading engine may retrieve final data object 524G and final data object 524H such that all the final data objects (e.g., final data object 522A, final data object 522B, final data object 524G, and final data object 524H) are loaded and available for the decision service.

However, in some examples, one or more of the processes may fail or otherwise be delayed. For independent data objects, the data loading engine may dynamically update the graph to mitigate delays. In FIG. 5B, the data loading engine may encounter a failure of the retrieval of final data object 522A at level 1. In response, the data loading engine may reallocate the failed retrieval to a subsequent stage having available processor capacity. For example, level 5 in graph 501 may have sufficient excess execution time to accommodate the execution time for final data object 522A, and the data loading engine may accordingly dynamically reallocate final data object 522A. Thus, rather than waiting on retrying the retrieval of final data object 522A to complete the first stage (e.g., level 1 of graph 501), the data loading engine may instead proceed to the next stage (e.g., level 2 of graph 501).

The final data objects may then be available as inputs for the decision service to perform a prediction/decision and respond to the request (e.g., decision service 350 may perform the requested prediction and accordingly respond to service gateway 352). In some examples, the initial request may require accessing multiple AI models and/or decision engines (e.g., as may be determined by model metadata 364 and executed by model executor 368). For example the final data objects may correspond to inputs for multiple different models such that the decision service may provide the proper inputs to the respective models. The data loading engine allows an efficient complex data loading process for all the inputs, rather than having to load inputs for each model separately.

FIG. 6 is a flow diagram of an example computer-implemented method 600 for complex data loading using a data loading engine. The steps shown in FIG. 6 may be performed by any suitable computer-executable code and/or computing system, including the system(s) illustrated in FIGS. 1 and/or 2. In one example, each of the steps shown in FIG. 6 may represent an algorithm whose structure includes and/or is represented by multiple sub-steps, examples of which will be provided in greater detail below.

As illustrated in FIG. 6, at step 602 one or more of the systems described herein may determine, for a data loading process that includes retrieving a plurality of data objects using at least one data producer and at least one data consumer to produce a final set of data objects, a dependency hierarchy for the plurality of data objects, the at least one data producer, and the at least one data consumer. For example, data store module 104, transformer module 106, and/or graph module 108 may identify the producers and consumers needed for retrieving the desired plurality of data objects (e.g., one or more instances of data object 122 and/or transformed data object 124), and determine the data dependencies.

The systems described herein may perform step 602 in a variety of ways. In some examples, data store module 104 may determine the dependency hierarchy by identifying nodes having a common data producer (e.g., similar to data analyzer 304 identifying common data stores as described above). In some examples, transformer module 106 may determine the dependency hierarchy by identifying nodes having a common data consumer (e.g., similar to data analyzer 304 identifying common transformers as described above).

In some examples, the plurality of data objects may correspond to a data context (e.g., data context 126) for configuring a data producer, an intermediate data object (e.g., an instance of data object 122), or an output data object (e.g., an instance of transformed data object 124) for the final set of data objects. In some examples, a data producer (which in some examples may be implemented with data store module 104) may correspond to a data store configured to output a requested data object, and/or a data transformer configured to output a transformed data object. In some examples, a data consumer (which in some examples may be implemented with transformer module 106) may correspond to a data store configured to receive a data context, and/or a data transformer configured to receive a data object input.

In some examples, data store module 104, transformer module 106, and/or graph module 108 may determine the dependency hierarchy by identifying one or more independent nodes having no prerequisite nodes or dependent nodes. For instance, data store module 104 and/or transformer module 106 may identify nodes which have no data routes to data consumers or data producers (e.g., similar to data analyzer 304 identifying independent data objects as described above).

At step 604 one or more of the systems described herein may generate, based on the dependency hierarchy, a graph including a plurality of levels between a root node and a final node corresponding to the final set of data objects, wherein each of the plurality of levels includes one or more nodes representing one or more of the plurality of data objects, the at least one data producer and the at least one data consumer, and links from nodes of one of the plurality of levels to a next level of the plurality of levels represent data routes. For example, graph module 108 may generate a graph (e.g., graph 128), similar to the graphs illustrated in FIGS. 4, 5A, and 5B.

The systems described herein may perform step 604 in a variety of ways. In some examples, graph module 108 may generate the graph by directing data routes from the common data producer to the nodes (e.g., batching the retrieval similar to data analyzer 304 grouping/batching retrievals as described above). In some examples, graph module 108 may generate the graph by directing data routes from the nodes to the common data consumer (e.g., batching the transformation similar to data analyzer 304 grouping/batching transformations as described above).

Further, in some examples, each level of the plurality of levels may represent processor cycles, and graph module 108 may build the graph by allocating nodes to each of the plurality of levels based on availability of the processor cycles without exceeding a threshold number of cycles for each level (e.g., similar to AI model 312 allocating independent data objects based on execution times as described above). In some examples, graph module 108 may identify the availability of the processor cycles based on historical data of execution times (e.g., similar to AI model 312 as described above). In some examples, graph module 108 may allocate nodes by allocating an independent node to a level with sufficient available processor cycles for the independent node (e.g., similar to AI model 312 as described above).

At step 606 one or more of the systems described herein may execute the data loading process based on the data routes defined by the plurality of levels to produce the final set of data objects. For example, retrieval module 110 may execute graph 128 to produce the desired final set of data objects.

The systems described herein may perform step 606 in a variety of ways. In some examples, retrieval module 110 may execute the data routes level-by-level (e.g., similar to graph executor 310 as described above). In some examples, retrieval module 110 may detect a failed node on a currently executing level. In response, retrieval module 110 may dynamically reallocate the failed node to a subsequent level based on the availability of the processor cycles of remaining levels (e.g., similar to graph executor 310 and/or data loading engine 370 reallocating a failed retrieval as described above).

In some examples, after retrieval module 110 completes executing the graph, the data objects may be available as inputs, such as to a decision service (e.g., decision service 350) or other engine requiring data inputs from a complex data loading process.

As detailed above, a decision-based system may use a decision engine. In one non-limiting example, a financial/payment service may use a decision engine for multiple fraud analyses on user operations such as onboarding, transaction processing, post transaction processing, dispute, etc., to make appropriate decisions on each operation. The decision-making process may involve numerous (e.g., hundreds or thousands of) variables and model executions with context data and context associated aggregated and/or raw data. Generally, this data extraction may be performed as a step of processes. Some data may need to be processed one after another, and some data may need to be processed in parallel depending on relationships and dependencies between different data. This data may generally be extracted from multiple sources such as a cache, a set of microservices, direct database calls, etc. Organizing all the data and metadata about all the required data efficiently and processing/transforming of this data may significantly impact an overall time that a decision engine may need to process a request.

The present disclosure provides an efficient data loading engine that may be light weight (e.g., having a low memory footprint) and highly scalable. As detailed above, when a decision engine receives a request, the decision engine may identify the models and required data for executing the models. This identified data set may be passed to a data loading engine for analysis and efficient execution structure by using a Directed Acyclic Graph (DAG).

In one implementation, the data loading engine may identify every independent piece of data and create a metadata set for each data. The data loading engine may analyze each data for source neighborhood such that IO (input/output) calls may be grouped as batches. The data loading engine may further sub-group batches depending on additional dependencies such as transformation of the data and a best transformation library that may be used for efficient transformation.

The data loading engine may analyze each data's dependency with other needed data to build a dependency hierarchy. The data loading engine may structure unrelated data for processing in parallel mode along with other data at the same level of the DAG depending on the number of nodes that can execute in parallel with other digraph tasks. The data loading engine may intelligently decide this task parallelization by dynamically allotting the nodes to the level of the DAG for maximum or otherwise efficient utilization of available execution resources in the environment where data processing is executing and the maximum execution time of any node at that specific level of the graph. The data loading engine may use historic data processing stats for this calculation.

In some examples, if any of the dynamically allotted nodes fail to execute at a certain level of the graph (e.g., because of timeout or any other system related issues), the data loading engine may dynamically propagate or otherwise reallot the failed nodes to a next calculated level (and/or other subsequent levels) of the graph for further processing.

In one example, a request may need to execute a model 1, a model 2, and a model 3. Model 1 may use data for a receiver context, including a receiver account number, receiver transaction count metrics (e.g., a count of transactions below $50, a count of transactions below $100, a count of transactions declined, a receiver token count such as online or offline exemptions, receiver details such as phone number, zip code, credit payments, etc.). Model 2 may use similar data as model 1 but in a sender context. Model 3 may use contextual data, third party scores, and externally-provided decisions. For the given request, the data loading engine described herein may identify the models and required inputs, and efficiently load all of the inputs as a single data loading process rather than disparate loading processes for each model.

As detailed above, the systems and methods provide various advantages for complex data loading processes, including overall performance improvement of request processing, saving time, resources, and/or operational costs, efficient resource-based handling of independent data processing, etc.

In some aspects, the techniques described herein relate to a system including: a processor; and a non-transitory computer-readable medium having stored thereon instructions that are executable by the processor to cause the system to perform operations including: receiving a request for a plurality of data items; identifying one or more data stores related to the request; grouping data retrievals for the request based on common data stores; identifying at least one data transformer related to the request; grouping data transformations for the request based on common data transformers; building a graph based on the grouped data retrievals and the grouped data transformations; and retrieving the plurality of data items based on the graph.

In some aspects, the techniques described herein relate to a system, wherein building the graph includes: identifying data dependencies between the plurality of data items; and organizing data routes for the grouped data retrievals and the grouped data transformations based on the data dependencies.

In some aspects, the techniques described herein relate to a system, wherein building the graph includes: determining a threshold execution time for each level of the graph; determining an expected execution time for each of the data retrievals and the data transformations; and organizing the data routes based on a total expected execution time not exceeding the threshold execution time for each level of the graph.

In some aspects, the techniques described herein relate to a system, wherein building the graph includes: identifying one or more independent data items; determining an expected execution time for each of the one or more independent data items; and organizing the one or more independent data items into the levels of the graph based on not exceeding the threshold execution time for each level of the graph.

In some aspects, the techniques described herein relate to a non-transitory computer-readable medium having stored thereon instructions that are executable by a processor of a computing system to cause the computing system to perform operations including: receiving a request for a plurality of data items that includes retrieving one or more data items from one or more data sources and transforming at least one of the one or more data items using at least one data transformer; determining which of the one or more data items are to be transformed using the at least one data transformer; creating a graph based on batch retrieval of data items from common data sources and batch transformation of data items having common transformations organized into stages based on expected processor utilization; and executing the graph by executing successive stages to output the requested plurality of data items.

In some aspects, the techniques described herein relate to a non-transitory computer-readable medium, wherein the instructions further cause the computing system to perform operations including: identifying one or more data items having no prerequisites and no transformations; and allocating a retrieval of the one or more data items into a stage based on an available processor capacity for the stage.

In some aspects, the techniques described herein relate to a non-transitory computer-readable medium, wherein the instructions further cause the computing system to perform operations including: dynamically updating, in response to a failure of the retrieval of the one or more data items when executing the stage, the graph by moving the failed retrieval of the one or more data items into a second stage after the stage based on an available processor capacity for the second stage.

In some aspects, the techniques described herein relate to a computer-implemented method including: determining, for a data loading process that includes retrieving a plurality of data objects using at least one data producer and at least one data consumer to produce a final set of data objects, a dependency hierarchy for the plurality of data objects, the at least one data producer, and the at least one data consumer; generating, based on the dependency hierarchy, a graph including a plurality of levels between a root node and a final node corresponding to the final set of data objects, wherein each of the plurality of levels includes one or more nodes representing one or more of the plurality of data objects, the at least one data producer and the at least one data consumer, and links from nodes of one of the plurality of levels to a next level of the plurality of levels represent data routes; and executing the data loading process based on the data routes defined by the plurality of levels to produce the final set of data objects.

In some aspects, the techniques described herein relate to a computer-implemented method, wherein determining the dependency hierarchy further includes identifying nodes having a common data producer.

In some aspects, the techniques described herein relate to a computer-implemented method, wherein generating the graph further includes directing data routes from the common data producer to the nodes.

In some aspects, the techniques described herein relate to a computer-implemented method, wherein determining the dependency hierarchy further includes identifying nodes having a common data consumer.

In some aspects, the techniques described herein relate to a computer-implemented method, wherein generating the graph further includes directing data routes from the nodes to the common data consumer.

In some aspects, the techniques described herein relate to a computer-implemented method, wherein each level of the plurality of levels represents processor cycles and building the graph further includes allocating nodes to each of the plurality of levels based on availability of the processor cycles without exceeding a threshold number of cycles for each level.

In some aspects, the techniques described herein relate to a computer-implemented method, wherein the availability of the processor cycles is based on historical data of execution times.

In some aspects, the techniques described herein relate to a computer-implemented method, wherein executing the data loading process further includes: detecting a failed node on a currently executing level; and dynamically reallocating the failed node to a subsequent level based on the availability of the processor cycles of remaining levels.

In some aspects, the techniques described herein relate to a computer-implemented method, wherein allocating nodes further includes allocating an independent node to a level with sufficient available processor cycles for the independent node.

In some aspects, the techniques described herein relate to a computer-implemented method, wherein determining the dependency hierarchy further includes identifying one or more independent nodes having no prerequisite nodes or dependent nodes.

In some aspects, the techniques described herein relate to a computer-implemented method, wherein the at least one data producer corresponds to at least one of: a data store configured to output a requested data object; or a data transformer configured to output a transformed data object.

In some aspects, the techniques described herein relate to a computer-implemented method, wherein the at least one data consumer corresponds to at least one of: a data store configured to receive a data context; or a data transformer configured to receive a data object input.

In some aspects, the techniques described herein relate to a computer-implemented method, wherein the plurality of data objects corresponds to at least one of: a data context for configuring a data producer; an intermediate data object; or an output data object for the final set of data objects.

As detailed above, the computing devices and systems described and/or illustrated herein broadly represent any type or form of computing device or system capable of executing computer-readable instructions, such as those contained within the memory devices described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), hardware accelerators, graphics processing units (GPUs), co-processors, portions of one or more of the same, variations or combinations of one or more of the same, or any other suitable physical processor.

Although described/illustrated as separate elements, the instructions described and/or illustrated herein may represent portions of a single instruction, code, program, and/or application. In addition, in certain embodiments one or more of these instructions may represent one or more software applications or programs that, when executed by a computing device, may cause the computing device to perform one or more tasks. For example, one or more of the instructions described and/or illustrated herein may represent instructions stored and configured to run on one or more of the computing devices or systems described and/or illustrated herein. One or more of these instructions may also represent all or portions of one or more special-purpose computers configured to perform one or more tasks.

In addition, one or more of the modules described herein may transform data, physical devices, and/or representations of physical devices from one form to another. For example, one or more of the instructions recited herein may receive requested data to be transformed, transform the data to a desired format, output a result of the transformation as a graph, use the result of the transformation to perform analysis and/or decision-making, and store the result of the transformation to perform data loading. Additionally or alternatively, one or more of the instructions recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A system comprising:
a processor; and
a non-transitory computer-readable medium having stored thereon instructions that are executable by the processor to cause the system to perform operations comprising:
receiving a request for a plurality of data items;
identifying one or more data stores related to the request;
grouping data retrievals for the request based on common data stores;
identifying at least one data transformer related to the request;
grouping data transformations for the request based on common data transformers;
building a graph based on the grouped data retrievals and the grouped data transformations;
retrieving the plurality of data items based on the graph; and
updating the graph based on a performance associated with the processor.

2. The system of claim 1, wherein building the graph comprises:
identifying data dependencies between the plurality of data items; and
organizing data routes for the grouped data retrievals and the grouped data transformations based on the data dependencies.

3. The system of claim 2, wherein building the graph comprises:
determining a threshold execution time for each level of the graph;
determining an expected execution time for each of the data retrievals and the data transformations; and
organizing the data routes based on a total expected execution time not exceeding the threshold execution time for each level of the graph.

4. The system of claim 3, wherein building the graph comprises:
identifying one or more independent data items;
determining an expected execution time for each of the one or more independent data items; and
organizing the one or more independent data items into the levels of the graph based on not exceeding the threshold execution time for each level of the graph.

5. A non-transitory computer-readable medium having stored thereon instructions that are executable by a processor of a computing system to cause the computing system to perform operations comprising:
receiving a request for a plurality of data items that includes retrieving one or more data items from one or more data sources and transforming at least one of the one or more data items using at least one data transformer;
determining which of the one or more data items are to be transformed using the at least one data transformer;
creating a graph based on batch retrieval of data items from common data sources and batch transformation of data items having common transformations organized into stages based on expected processor utilization;
executing the graph by executing successive stages to output the requested plurality of data items; and
dynamically reorganizing the stages based on updated processor utilization.

6. The non-transitory computer-readable medium of claim 5, wherein the instructions further cause the computing system to perform operations comprising:
identifying one or more data items having no prerequisites and no transformations; and
allocating a retrieval of the one or more data items into a stage based on an available processor capacity for the stage.

7. The non-transitory computer-readable medium of claim 6, wherein the instructions further cause the computing system to perform operations comprising:
dynamically updating, in response to a failure of the retrieval of the one or more data items when executing the stage, the graph by moving the failed retrieval of the one or more data items into a second stage after the stage based on an available processor capacity for the second stage.

8. A computer-implemented method comprising:
determining, for a data loading process that includes retrieving a plurality of data objects using at least one data producer and at least one data consumer to produce a final set of data objects, a dependency hierarchy for the plurality of data objects, the at least one data producer, and the at least one data consumer;
generating, based on the dependency hierarchy, a graph including a plurality of levels between a root node and a final node corresponding to the final set of data objects, wherein each of the plurality of levels includes one or more nodes representing one or more of the plurality of data objects, the at least one data producer and the at least one data consumer, and links from nodes of one of the plurality of levels to a next level of the plurality of levels represent data routes;
executing the data loading process based on the data routes defined by the plurality of levels to produce the final set of data objects; and
dynamically updating the graph in response to a performance of the executed data loading process.

9. The computer-implemented method of claim 8, wherein determining the dependency hierarchy further comprises identifying nodes having a common data producer.

10. The computer-implemented method of claim 9, wherein generating the graph further comprises directing data routes from the common data producer to the nodes.

11. The computer-implemented method of claim 8, wherein determining the dependency hierarchy further comprises identifying nodes having a common data consumer.

12. The computer-implemented method of claim 11, wherein generating the graph further comprises directing data routes from the nodes to the common data consumer.

13. The computer-implemented method of claim 8, wherein each level of the plurality of levels represents processor cycles and building the graph further comprises allocating nodes to each of the plurality of levels based on availability of the processor cycles without exceeding a threshold number of cycles for each level.

14. The computer-implemented method of claim 13, wherein the availability of the processor cycles is based on historical data of execution times.

15. The computer-implemented method of claim 13, wherein executing the data loading process further comprises:
detecting a failed node on a currently executing level; and
dynamically reallocating the failed node to a subsequent level based on the availability of the processor cycles of remaining levels.

16. The computer-implemented method of claim 13, wherein allocating nodes further comprises allocating an independent node to a level with sufficient available processor cycles for the independent node.

17. The computer-implemented method of claim 8, wherein determining the dependency hierarchy further comprises identifying one or more independent nodes having no prerequisite nodes or dependent nodes.

18. The computer-implemented method of claim 8, wherein the at least one data producer corresponds to at least one of:
a data store configured to output a requested data object; or
a data transformer configured to output a transformed data object.

19. The computer-implemented method of claim 8, wherein the at least one data consumer corresponds to at least one of:
a data store configured to receive a data context; or
a data transformer configured to receive a data object input.

20. The computer-implemented method of claim 8, wherein the plurality of data objects corresponds to at least one of:
a data context for configuring a data producer;
an intermediate data object; or
an output data object for the final set of data objects.
